(19) United States
(12) Patent Application Publication
(10) Pub. No.: US 2003/0153986 A1
(43) Pub. Date: Aug. 14, 2003

(54) Filtered variable control method for activating an electrical device

(75) Inventors: Timothy I. Salsbury, Whitefish Bay, WI (US); Kirk H. Drees, Cedarburg, WI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/075,177

(22) Filed: Feb. 14, 2002

(51) Int. Cl. G05B 11/01

(52) U.S. Cl. 700/11

(57) ABSTRACT

A method and system for controlling an environmental management system (e.g., an HVAC system) that controls an environmental parameter of a downstream controlled space (e.g., the temperature of a room in a building). The method includes providing a feedback control loop for controlling a controlled environmental parameter (e.g., the supply air temperature), and generating a feedback control signal based on the controlled parameter and a dynamic (e.g., a time constant) of the downstream controlled space. The system includes a device for receiving a signal representative of a measured value of a controlled parameter having a time constant that is smaller than the time constant of the downstream space. The system also comprises a filter, a device for producing a control signal representative of a deviation between a filtered value and a desired value of the controlled parameter, and a device for converting the control signal into a pulsed output signal that turns the device on and off.

### CROSS-REFERENCE TO RELATED APPLICATIONS

U.S. Patent Application Ser. No. 10/040,069 titled “Pulse Modulation Adaptive Control Method For Activating An Electrical Device” filed Nov. 7, 2001 (Atty. Dkt. No. 81445-255), is hereby incorporated herein by reference.

### FIELD OF THE INVENTION

The present invention relates to facility management systems which control equipment, such as heating, ventilation and air conditioning equipment; and more particularly to a system and method of filtered variable control of the operation of devices that operate at discrete states.

### BACKGROUND OF THE INVENTION

It is known to apply feedback control of a system with one or more on/off devices. An example of a feedback control loop 10 is shown in FIG. 1. Control loop 10 includes a conventional feedback controller 12 that produces an analog control signal u in response to a deviation of the controlled variable y from a desired setpoint SP. The control signal u is applied to a switching law 14 (e.g., a pulse width modulation (PWM) controller, or the like) positioned intermediate to the feedback controller 12 and a controlled system 16. (By contrast, for a system that can be modulated, this control signal u is applied directly to a driver for the controlled system 16, which produces the desired change.) The switching law 14 responds to the control signal u by producing a pulsed output signal h (i.e., a sequence, in time, of on and off epochs) that turns the discrete devices of the controlled system 16 on and off.

The controllers for such conventional systems typically operate based on sensing a variable or parameter (i.e., a “controlled variable”) associated with the controlled devices. In these systems, however, there is often another variable “downstream” from the controlled variable (i.e., a “downstream variable”) that has variations which are more important to the desired operation of the system than the variations in the controlled variable. In situations where the time constant to effect change in the downstream variable is significantly different (e.g., larger) than the time constant for the controlled variable, the controlled variable tends to vary widely each time the devices are switched on or off, even though there is little or no change in the downstream variable. This makes it make it difficult to apply effective feedback control.

An example of such a system is a control loop for a heating, ventilation and air conditioning (HVAC) system. The HVAC system includes ventilation equipment that supplies heated or cooled air to one or more controlled spaces or target zones of a building. To maintain the controlled space at the desired temperature, the thermal output of the HVAC system must be regulated. With many HVAC systems, the ventilation equipment cannot be modulated over a continuous range but instead can only be switched to an “on” or “off” state. There are various types of known control methods that can be used to control these types of discrete systems, a well-known example being pulse width modulation (PWM).

One commonly employed HVAC system that uses such discrete devices is known as a direct expansion (“DX”) cooling system. DX cooling systems typically include a feedback controller that operates one or more compressors that can only be switched on or off. In most installations, the on/off switching of the compressors is controlled based on the temperature of the air as it comes off of the DX cooling coil (i.e., the “supply air temperature”) because it is typically not feasible to control the system by measuring temperatures in the controlled space. Based on the desired system performance, a set-point (in combination with other inputs or additional heating or cooling sources within the controlled space) is selected to provide the desired temperature of the controlled space. (For example, in a DX cooling system this set-point is typically between about 40° F. and about 65° F.—most typically about 55° F.) The supply air temperature (i.e., measured controlled variable y) is fed back to the feedback controller. The feedback controller compares the supply air temperature to the set-point and issues the control signal u to the controlled devices (e.g., turning the compressors on or off).

In such HVAC systems, the supply air temperature (i.e., the controlled variable) tends to change relatively quickly after the compressors are turned on or off. For example, when a compressor turns on, the supply air coming off the DX coil will cool rapidly; and when a compressor turns off, the air coming off the DX coil will warm rapidly. Such a quickly-reacting control loop tends to cause substantial oscillations in the controlled variable, which get fed back the controller. These wide variations or oscillations make it difficult for a feedback controller to provide stable regulation. Also, the compressors must be switched on and off in frequent, short durations in an effort to meet the set-point when high performance is desired (i.e., when the controlled space has a narrow allowable temperature range). Such frequent cycling on and off is hard on the components and can lead to premature failure. Also, such a control loop having a small time constant relative to the maximum switching frequency of the components tends to make it difficult to apply feedback control.

As is well known in the HVAC field, the temperature in the controlled space (the downstream variable) is more important to the desired operation of the system than the temperature of the air coming off the cooling coil (the controlled variable). Persons located in the controlled space only care about the temperature in their immediate environment; the temperature at the cooling devices at a remote location is not relevant to anyone other than the building operators. Controlling the temperature in the controlled space by monitoring the temperature at the cooling devices is complicated by the fact that the controlled space temperature typically responds relatively slowly to switching of the cooling devices, i.e., the time constant for the downstream variable is larger than the time constant for the controlled variable. This is largely due to the substantial volume of air typically found in the controlled space. As a result, the controller may be operating contrary to the desired performance of the system due to the fact that the controlled variable is insufficiently damped to reflect the true variations occurring in the downstream variable.

Although use of the downstream variable in the control scheme could be used to address the problem of insufficient damping, this downstream variable is often unavailable to the cooling device controllers in known HVAC systems. Even if the measurement were available, the existence of multiple controlled spaces and disturbances occurring between the cooling device and the controlled space would make it unreliable. Thus, it would be advantageous to provide a filtered variable control method for controlling a discrete process, such as one or more compressors in a HVAC system. It would also be advantageous to provide a filtered variable (e.g., a supply air temperature measurement) that has dynamics representative of those associated with the controlled space. It would also be advantageous to pass a supply air temperature measurement through a filter that has a time constant comparable to the time constant of the controlled space. It would further be desirable to provide for a filtered variable control method having one or more of these or other advantageous features.

### SUMMARY OF THE INVENTION

The present invention relates to a method for controlling a discrete system that affects a target parameter of a target zone. The method comprises providing a feedback control loop for controlling a controlled parameter of the discrete system. The method further comprises generating a feedback signal based upon the controlled parameter and a dynamic representative of the target zone. The discrete system may be an environmental management system, in which case the controlled environmental parameter may be the temperature of air supplied to the target zone (e.g., one or more rooms in the building that receive the conditioned air). The step of generating the feedback signal may include passing a measured value for the controlled parameter through a filter, such as a first-order filter with a time constant based on the dynamic component of the target zone.

The present invention also relates to a method for controlling a discrete device that affects a parameter of a target zone having a first time constant. The method comprises receiving a signal representative of a measured value of a controlled parameter. The controlled parameter has a second time constant which is smaller than the first time constant. The method also comprises passing the measured value through a filter using a third time constant to provide a filtered value. The method further comprises producing a control signal representative of a deviation between the filtered value and a desired value of the controlled parameter, and converting the control signal into a pulsed output signal that turns the device on and off.

The present invention further relates to a system for controlling a discrete device that affects a parameter of a target zone having a first time constant. The system comprises means for receiving a signal representative of a measured value of a controlled parameter having a second time constant. The second time constant is smaller than the first time constant. The system also comprises means for passing the measured value through a filter using a third time constant to provide a filtered value. The system further comprises means for producing a control signal representative of a deviation between the filtered value and a desired value of the controlled parameter, and means for converting the control signal into a pulsed output signal that turns the device on and off.

The present invention further relates to various features and combinations of features shown and described in the disclosed embodiments.

### DESCRIPTION OF THE FIGURES

FIG. 1 is a block schematic diagram of a conventional feedback control loop system.

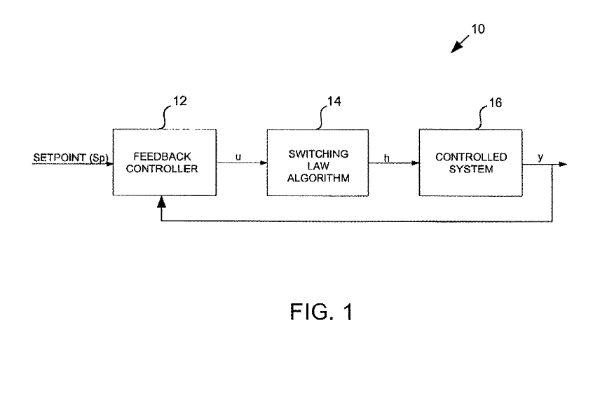

FIG. 2 is a block schematic diagram of one embodiment of a filtered variable feedback control loop system according to the present invention.

FIG. 3 is a schematic diagram of an air-handling system that utilizes the filtered variable control system according to a preferred embodiment of the present invention.

FIGS. 4-7 graphically illustrates parameters and signals in connection with the filtered variable control system and method.

### DETAILED DESCRIPTION OF A PREFERRED AND OTHER EXEMPLARY EMBODIMENTS

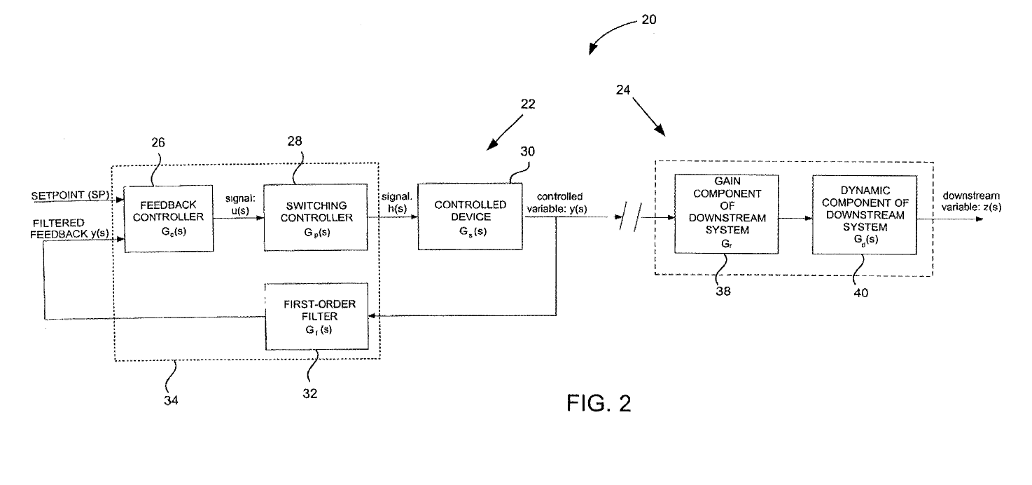

FIG. 2 shows a filtered variable feedback control loop system 20 according to a preferred embodiment. Filtered control system 20 includes a feedback control loop 22 and a downstream (controlled) system 24. Control loop 22 is configured to filter a controlled parameter or variable y(s) according to the dynamics of a downstream variable z(s) for downstream system 24.

Control loop 22 includes a feedback controller 26, a switching law (shown as a switching controller 28 that operates from a switching law algorithm), a controlled system (shown as a controlled device 30), and a filter 32. As explained in detail below, filter 32 is applied to controlled variable y(s) so that controlled device 30 ultimately responds more appropriately to the slower-reacting downstream variable z(s). According to a preferred embodiment, feedback controller 26, switching controller 28, and filter 32 are part of a single controller 34. According to an alternative embodiment, more than one controller may be used for providing the feedback controller 26, switching controller 28, and filter 32. According to other alternative embodiments, any of a variety of computing devices may be used in the control loop 22.

Feedback controller 26 produces a control signal u(s) (preferably an analog control signal) representative of the deviation of the filtered controlled variable signal \overline{y}(s) from a desired set-point SP. According to an exemplary embodiment, feedback controller 26 is of conventional design and may be a proportional integral (PI) type device, such as disclosed in U.S. Pat. No. 5,506,768 the entire contents of which are hereby incorporated by reference herein. Alternatively, the feedback controller may be a proportional integral derivative (PID) type device, or the like. (According to other alternative embodiments, digital logic could be used along with analog-to-digital and digital-to-analog converters.)

The control signal u(s) preferably has values between zero and one (i.e., between 0% and 100%) in response to the inputs to feedback controller 26. The value of control signal u(s) provides a relative indication of the magnitude (0% to 100%) that the controlled device 30 needs to be operated at in order to bring the downstream variable z(s) to the desired level or set point SP, i.e., the control signal u(s) is representative of the difference or “error” between the setpoint SP and the filtered controlled variable signal \overline{y}(s).

The control signal u(s) is applied to the switching law algorithm interposed between feedback controller 26 and the driver for the controlled device 30. According to a preferred embodiment, the switching law algorithm is provided in a pulse modulation adaptive controller (“PMAC”), such as described in U.S. patent application Ser. No. 10/040,069 titled “Pulse Modulation Adaptive Control Method For Activating An Electrical Device” filed Nov. 7, 2001 (Atty. Dkt. No. 81445-255), which is hereby incorporated herein by reference. According to an alternative embodiment, the switching law algorithm is provided in a conventional pulse width modulation (“PWM”) controller.

Switching controller 28 responds to the control signal u(s) by producing an output signal h(s) (i.e., a sequence, in time, of on and off epochs; which is also known as a “pulse stream” or “pulse train” and shown in FIG. 7). This output signal h(s) is the input signal to controlled device 30 and turns controlled device 30 on and off. The output signal h(s) has a cycle period and an on-time that is a fraction of the total cycle period. In a preferred embodiment, both the cycle period and the on-time are functions of the control signal u(s).

Downstream variable z(s) is comprised of a gain component 38 and a dynamic component 40 (e.g., how quickly or slowly the downstream variable z(s) responds to changes to the input, reflected as a time constant T_{D}). According to an exemplary embodiment, filter 32 provides a filtered signal representative of z(s). As such, filter 32 provides feedback controller 26 with an approximation of the dynamics of the downstream variable z(s) of the downstream system 24 being controlled.

Controlled variable y(s) has a time constant T_{C}, which is smaller (i.e., shorter) than the time constant T_{D} of the downstream variable z(s). As such, the controlled variable y(s) may exhibit large oscillations as controlled device 30 is switched on and off, which tends to inhibit effective application of feedback control. To overcome this problem, controlled variable y(s) is passed through filter 32 which has a time constant τ representative of the dominant time constant T_{D} of the downstream system 24. Thus, filter 32 produces a filtered controlled variable signal \overline{y}(s) in response to the controlled variable y(s) input. Control loop 22 then controls the filtered controlled variable \overline{y}(s) to a tolerance level related to the desired variation in the downstream variable z(s) (i.e., dynamic component 40), rather than the one actually being controlled. Also, knowing the time constant τ of the filtered controlled variable is intended to reduce potential for errors in estimating a value in switching controller 28. The potential for errors in estimating a value in switching controller 28 is reduced when the time constant τ of the filtered controlled variable is known.

According to a preferred embodiment, filter 32 is a first-order filter represented by the following transfer function:

$${G}_{f} ( s ) = \frac{1}{1 + τ s} \qquad ( 1 )$$

where G_{f}(s) is the filtered controlled variable, τ is the filter time constant, and s is the Laplace operator.

According to a preferred embodiment, controlled device 30 is implemented in discrete-time, such that filter 32 may be expressed as the following exemplary recursive equation:

$${\overline{y}}_{k} = exp ( \frac{- Δ t}{τ} ) {\overline{y}}_{k - 1} + ( 1 - exp ( \frac{- Δ t}{τ} ) ) {y}_{k} \qquad ( 2 )$$

where \overline{y} is the filtered signal, y is the measured signal, Δt is the sampling interval, τ is the filter time constant, and k is a sample number. As such, y_{K} is the measured controlled signal and \overline{y}_{K-1} is the previous filtered controlled signal. Also, Δt is preferably set as a configuration parameter of controller 34. According to exemplary embodiments, Δt is measured in seconds, minutes, or the like. As such, the exponential function for the previous filtered signal

$$exp ( \frac{- Δ t}{τ} ) {\overline{y}}_{k - 1}$$

s a constant. The first-order filter 32 is applied to the faster reacting controlled variable using a time constant τ that is representative of the dominant time constant associated with the slower-reacting variable (i.e., the time constant T_{D}(s) of the downstream variable z(s)). The filtered variable \overline{y}(s) may then be controlled directly.

According to an exemplary embodiment, Gₛ(s) is representative of controlled device 30 and has a smaller dominant time constant than G_{d}(s)—which is representative of the dynamic component of downstream system 24—and G_{f}(s) is representative of the first order filter 32. The dynamic component, G_{d}(s) may be higher than first order, but using a first order filter is sufficient to synchronize the controlled device with the dynamic component of the downstream system. FIG. 2 illustrates the concept using transfer function blocks, where:

G_{f}(s)≈G_{d}(s) (3)

Accordingly, the controlled variable signal y(s) is filtered through first-order filter 32 using a time constant τ representative of the dominate time constant associated with the slower-reacting downstream variable z(s).

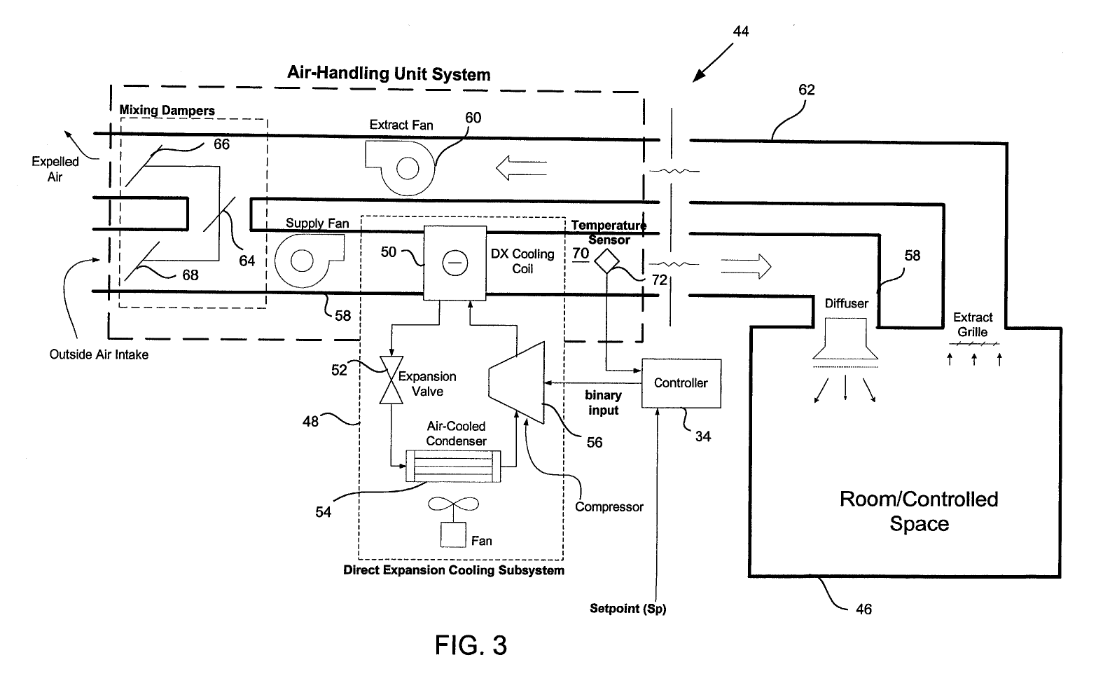

FIG. 3 illustrates an air-handling system 44 (e.g., an HVAC system) for controlling the environment of a controlled space or target zone 46. According to an exemplary embodiment, controlled space 46 comprises several rooms each of which receive air supplied by air handling system 44. Controlled space 46 may be any number of one or more rooms having any of a variety of configurations and may span one or more floors of a building (or be an entire building).

Air-handling system 44 includes a cooling subsystem 48 configured to remove heat from air being supplied to controlled space 46. A fluid circulates through a direct expansion cooling coil 50, then flows through an expansion valve 52 to a condenser coil 54 (e.g., outside the building) and through one or more compressors 56 before being returned to cooling coil 50. (Alternatively, air-handling system 44 may include a heating subsystem wherein a heating coil selectively receives heated water from a boiler when the room environment needs to be warmed.) Air in a supply duct 58 flows through cooling coil 50 before being fed into the controlled space 46. Air from the controlled space 46 is drawn by a fan 60 into a return duct 62 from which some of the air flows through a damper 64 and past cooling coil 50 to the supply duct 58. Some of the return air may be exhausted to the outside of the building through an outlet damper 66 and replenished by fresh outside air entering through an inlet damper 68. The dampers 64, 66, 68 may be opened and closed by actuators that are operated by a control loop such as well known to those skilled in the art.

Referring to FIGS. 2 and 3, the downstream variable z(s) relates to the temperature of the air in controlled space 46, and the controlled variable y(s) relates to the temperature of the air coming off the cooling coil 50 (the “supply air” 70). According to a preferred embodiment, controller 34 includes feedback controller 26, the switching law algorithm, and filter 32. According to an alternative embodiment, more than one controller may be used to provide the feedback controller, switching controller, and the first order filter. According to other alternative embodiments, any of a variety of computing devices may be used in the control loop 22.

A temperature sensor 72 measures the temperature of the supply air 70 so that this information is available to control loop 22.

Controller 34 for air-handling system 44 is configured to determine when and how many compressors 56 to run to meet the present thermal loading demands. According to an exemplary embodiment, each compressor 56 has two operational states: on and off. Depending upon the amount of cooling required to bring the temperature of supply air 70 to the desired set-point (SP) temperature, controller 34 may activate one or more compressors 56. If controller 34 detects that the temperature of supply air 70 needs to be adjusted, it switches one or more of the heating or cooling devices on or off. (Each cooling device when turned on always runs at full capacity, regardless of the degree to which the room temperature varies from the desired level).

According to an exemplary embodiment, controller 34 of air-handling system 44 controls one or more compressors 56 to run at full capacity (i.e., the compressors are left on), while another compressor is cycled on and off to meet the fractional cooling requirements. In another embodiment, the compressor that is cycled on and off is switched based on the PMAC algorithm described in U.S. patent application Ser. No. 10/040,069 and previously incorporated by reference herein. Alternatively, compressor 56 may be switched in accordance with a conventional pulse width modulation (PWM) algorithm. (The PMAC technique differs from prior PWM control methods in that both the on-time of the device and the cycle period are dynamically varied to meet the load demand of the system.)

As the number of compressors 56 running at any given time changes in response to the control signals from controller 34, the temperature of supply air 70 will oscillate in accordance with those changes.

In the air-handling system 44, the controlled variable y(s) is the actual measured value of an environmental characteristic or parameter of the air handling system 44 (e.g., the temperature of supply air 70 coming off the cooling coil(s) 50, as measured by the temperature sensor 72) and the set-point SP designates the desired supply air temperature.

According to an exemplary embodiment, the time constant of the air temperature in controlled space 46 is based on expected values for typical HVAC systems. By way of example and not limitation, a typical time constant for a controlled space of an HVAC system may be between about 20 and about 40 minutes. According to a typical embodiment, therefore, the time constant of the air temperature in controlled space 46 is about 30 minutes. According to alternative embodiments, the time constant for the downstream variable z(s) may be any of a variety of values or ranges, depending on the size and configuration of the controlled space 46, the capacity of the air-handling system 44, etc. Alternatively, the time constant of the air temperature in the controlled space 46 (i.e., the downstream variable z(s)) may be determined using any of a variety of empirical or analytical techniques (e.g., empirically determined by varying the supply air temperature and timing how long it takes for the temperature in the controlled space 46 to reach 63% of the steady state temperature).

According to a preferred embodiment, the time τ constant used by the filter 32 may be set during manufacturing of controller 34. According to an alternative embodiment, the time constant used by the filter may be programmed (or reprogrammed) after being installed. According to yet another embodiment, the time constant used by filter 32 may be analytically or mathematically calculated based on parameters of air-handling system 44 and parameters of the controlled space 46.

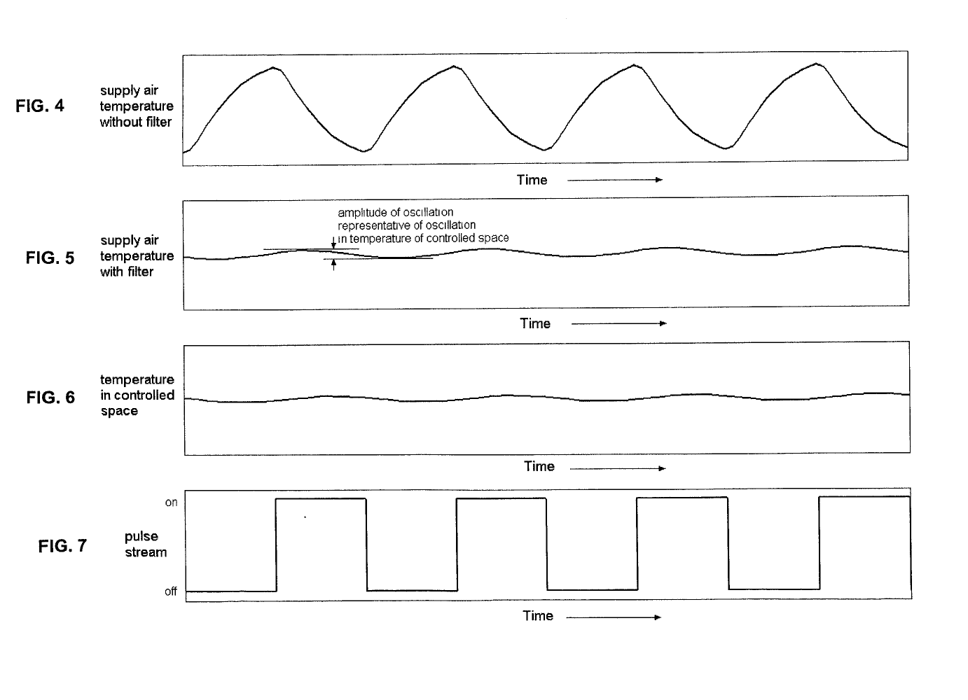

As shown in FIGS. 4-6, by applying such a filter to the controlled variable, the amplitude of the oscillations are reduced. FIGS. 4 shows the measurement of a supply air temperature 70 provided by a typical prior art HVAC to a downstream controlled space, while FIG. 6 shows the actual measured temperature in the controlled space. As typical for such prior art HVAC systems, the amplitude of the oscillations of the supply air temperature is significantly greater than the amplitude of oscillations of the temperature in the controlled space. By using a filter such as described above, the supply air temperature can be controlled to have oscillations of approximately the same magnitude as the oscillations in the controlled space. As persons skilled in the art will appreciate, this can significantly improve the efficiency of operation of the system.

It is also important to note that the construction and arrangement of the elements of the filtered variable control method for activating an electrical device as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. For example, while the components of the disclosed embodiments are illustrated to be designed for an air-handling or HVAC system, the features of the disclosed embodiments have a much wider applicability. For example, the filtered variable control method is adaptable for home, a workplace, or other institutional, public, government, educational, commercial, or municipal facility and the like. Further, the filtered variable control method is adaptable for other controlled environments, such as heat, humidity, pressure, filtering, airflow, and the like. Further, the filtered variable control method is adaptable for controlling water levels, water flow, chemical processing, and the like. Further, the filter could be implemented through hardware. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims.

What is claimed is:

1. A method for controlling a discrete system that affects a target parameter of a target zone, the method comprising:
providing a feedback control loop for controlling a controlled parameter of the discrete system; and
generating a feedback signal based upon the controlled parameter and a dynamic representative of the target zone.

2. The method of claim 1, wherein the discrete system is an environmental management system, the controlled parameter is a temperature of air supplied to the target zone, and the target parameter is the temperature in the target zone.

3. The method of claim 1, wherein generating the feedback signal includes passing a measured value for the controlled parameter through a filter.

4. The method of claim 3, further comprising sensing the controlled parameter to provide the measured value.

5. The method of claim 3, wherein the filter is a first order filter.

6. The system of claim 3, wherein the target parameter has a first time constant, the controlled parameter has a second time constant, and the dynamic is an approximation of the first time constant.

7. The method of claim 3, wherein the target parameter has a first time constant, the controlled parameter has a second time constant, and the dynamic is a third time constant, and further comprising the step of approximating the third time constant based on the first and second time constants.

8. The method of claim 3, wherein the target parameter has a first time constant, the controlled parameter has a second time constant, and the dynamic is a third time constant, and further comprising the step of determining the first time constant.

9. The method of claim 8, wherein determining the first time constant includes measuring the first time constant.

10. The method of claim 8, wherein determining the first time constant includes calculating the first time constant.

11. The method of claim 8, wherein determining the first time constant includes estimating the first time constant.

12. The method of claim 1, wherein the dynamic used for generating the feedback signal is a time constant of the target zone.

13. The method of claim 1, further comprising producing a pulsed output signal for turning at least one device of the discrete system on and off, the output signal being based on the feedback signal and a desired level for the controlled parameter.

14. The method of claim 13, wherein the discrete system is an environmental management system and the at least one device is a compressor.

15. The method of claim 1, wherein the discrete system is an environmental management system and the controlled parameter is a temperature of supply air coming off of a cooling element.

16. The method of claim 1, wherein the target zone comprises one or more rooms in a building.

17. A method for controlling a discrete device that affects a parameter of a target zone having a first time constant, the method comprising:
receiving a signal representative of a measured value of a controlled parameter, the controlled parameter having a second time constant which is smaller than the first time constant;
passing the measured value through a filter using a third time constant to provide a filtered value;
producing a control signal representative of a deviation between the filtered value and a desired value of the controlled parameter;
converting the control signal into a pulsed output signal that turns the device on and off.

18. The method of claim 17, wherein the discrete device is a compressor of an air handling unit and the controlled parameter is a temperature of air coming off an expansion coil coupled to the compressor.

19. The method of claim 17, wherein the filter is a first order filter.

20. The system of claim 17, wherein the third time constant is an approximation of the first time constant.

21. The method of claim 17, further comprising determining the first time constant.

22. The method of claim 21, wherein determining the first time constant includes estimating the first time constant.

23. The method of claim 17, wherein the control signal is an analog signal and converting the control signal includes applying a pulse width modulation control scheme.

24. The method of claim 17, further comprising sensing the controlled environmental parameter to provide the measured value.

25. The method of claim 17, wherein the target zone comprises one or more rooms in a building.

26. The method of claim 17, wherein the discrete device is part of an environmental control system for a facility.

27. A system for controlling a discrete device that affects a parameter of a target zone having a first time constant, the system comprising:
means for receiving a signal representative of a measured value of a controlled parameter having a second time constant, the second time constant being smaller than the first time constant;
means for passing the measured value through a filter using a third time constant to provide a filtered value;
means for producing a control signal representative of a deviation between the filtered value and a desired value of the controlled parameter;
means for converting the control signal into a pulsed output signal that turns the device on and off.

28. The system of claim 27, further comprising means for sensing the measured value.

29. The system of claim 27, wherein the third time constant is an approximation of the first time constant.

30. The system of claim 27, wherein the discrete device is a compressor of an air handling unit and the controlled environmental parameter is temperature of air coming off an expansion coil coupled to the compressor.

31. The system of claim 27, wherein the filter is a first order filter.

32. The system of claim 27, wherein the discrete device is part of an air-handling unit and the controlled parameter is a temperature of air supplied to the target zone.

33. The system of claim 32, wherein the target zone is a plurality of rooms.

34. The system of claim 27, further comprising a sensor configured to provide a measured value of the controlled parameter.

36. The system of claim 26, wherein the control signal is an analog signal and the converting means performs a pulse width modulation control scheme on the analog signal.
